(19) United States
(12) Patent Application Publication
(10) Pub. No.: US 2017/0277793 A1
(43) Pub. Date: Sep. 28, 2017

(54) NARRATED SEARCH RESULTS

(71) Applicant: NewsRx, LLC, Atlanta, GA (US)

(72) Inventors: Charles W. Henderson, Atlanta, GA (US); Alan D. Henderson, Watkinsville, GA (US); Chantay P. Jones, Marietta, GA (US); Kalani K. Rosell, New Haven, CT (US)

(21) Appl. No.: 15/079,314

(22) Filed: Mar. 24, 2016

(51) Int. Cl. G06F 17/30

(52) U.S. Cl. CPC G06F 17/30867; G06F 17/30477; G06F 17/30539; G06F 17/30554; G06F 17/3056

(57) ABSTRACT

Technologies are described herein for generating narrated search results. In some examples, a system will receive search results provided by one or more search engines. The system will analyze the search results and provide a narrated version of the search results.

### BACKGROUND

Conventional search engines can receive a query and provide one or more search results. A user or other entity may input a search string into an Internet search engine. The search engine may search an indexed set of Websites and return one or more results based on the search string and the particular searching algorithm used by the company offering the search engine.

It is with respect to these and other considerations that the disclosure made herein is presented.

### SUMMARY

Technologies are described herein for generating a narrated search result. In some examples, a system will receive search results provided by one or more search engines. The system will analyze the search results and provide a narrated version of the search results.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various technologies disclosed herein.

FIG. 2 is a flow diagram showing aspects of a method for generating narrated search results.

FIGS. 3A-3C shows an illustrative query interface used to generate narrated search results.

FIG. 4 is a computer architecture diagram illustrating an illustrative computer hardware and software architecture for a computing system capable of implementing aspects presented herein.

### DETAILED DESCRIPTION

The following detailed description is directed to technologies for generating a narrated search result. In accordance with examples of the technologies disclosed herein, a user can input a search engine query. The query can be applied to one or more Internet or other types of search engines. A narration system can receive the search results and generate a narrated version of the search results.

In some examples, the number of results returned from one search engine can generate information that may be difficult to understand as a collective. For example, a search on “fast cars” using the search engine DUCKDUCKGO can result in hundreds, if not thousands, of results, i.e. various websites that are considered by the algorithm used by a particular website to be relevant to the search. A user must sift through the titles of the search results and small summaries that are sometimes provided to use the search results, often selecting the highest ranking websites as determined by the search engine.

As can be understood, conventional search engines provide information in response to receipt of a search query. The results are ranked according to the particular algorithm used by the search engine and presented in an interface for the user. Other than the number of results and time taken to perform the search, there is usually no information provided about the search itself.

In various examples, the presently disclosed subject matter uses search results provided by various search engines, including search engines used to search for files on a computer, and determines information from the search results. In one examples, the narration generator receives search results from a search engine and access a number of websites listed in the search results. The search engine may determine various information from accessing the websites.

In one example, the search engine may use a natural language service to determine one or more concepts that are present in the search results. For example, a natural language service may use a technique called “buckets of similarity” that are categories that can be determined by statistical clustering. For example, the narration generator can analyze the search results and determine that a large percentage of the search results are foreign websites maintained by research organizations. Thus, in this example, the narrated search results can include a sentence such as, “To note, over 64% of the top 300 search results are from research organizations found outside of the United States.”

In another example, the natural language service can use concept mining to extract concepts from the search results. Some technologies use data mining and text mining. Concepts can provide insights into the meaning, provenance, and similarity of documents. For example, the narration generator can analyze the search results and determine that of the top 1000 results from three different search engines, a topic most consistently found in search results is the use of pain killers in root canal surgery. Thus, in this example, the narrated search results can include a sentence such as, “To note, most of the top 1000 search results discuss the use of pain killers in root canal surgery.” It should be understood that the presently disclosed subject matter is not limited to any particular data mining technology.

In some examples, the narrated search results can be presented as a series of concepts, or “narratives,” that are related. The various narratives can be integrated into one or more general narratives. For example, the individual narratives can be different foods. The results relating to different foods can be integrated into a general narrative of “food.” In some examples, the more general narratives can be organized in a manner similar to chapters in a book or sections of a textual report.

Through the use of various examples of the technologies described herein, some advantages may be provided. For example, the narration generator may provide information about the search in a format that allows a user to quickly review the search results instead of having to access and review each one individually. Further, in some examples, the narration generator may provide narrated search results that show that aspects of the search results, such as concepts and categories, may not comport with the information originally desired for the search query. These and other technical advances over conventional technologies are described in more detail below.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for a narrated search result will be presented.

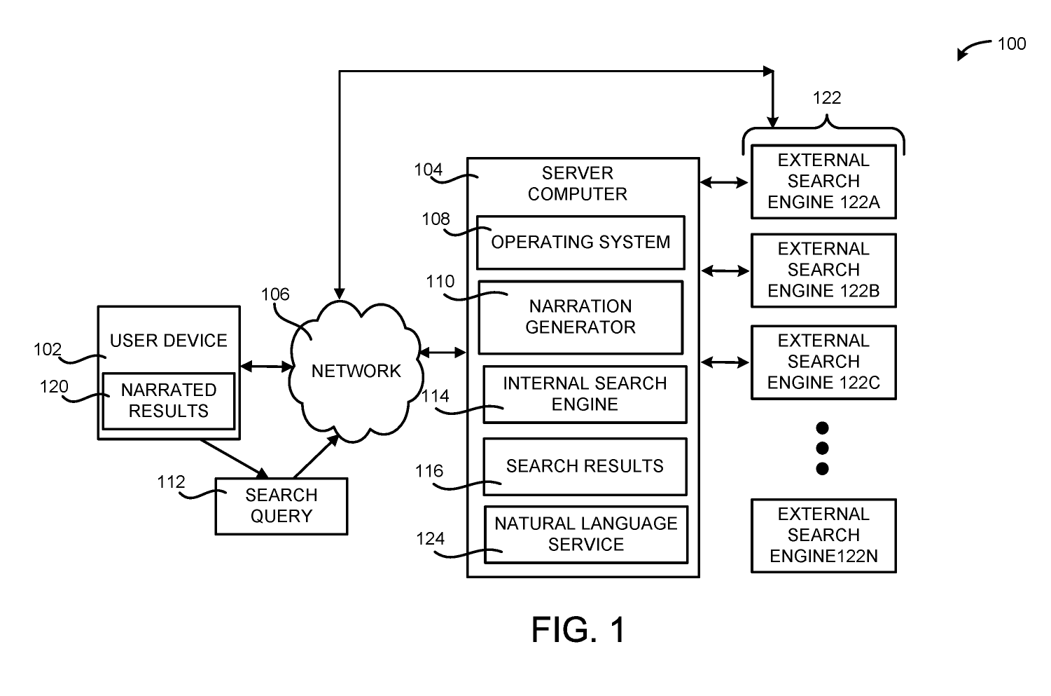

Referring now to FIG. 1, aspects of one operating environment 100 for the various technologies presented herein will be described. The operating environment 100 shown in FIG. 1 includes a user device 102. According to various configurations, the functionality of the user device 102 can be provided by a personal computer (“PC”) such as a desktop, tablet, or laptop computer system. In some other configurations, the functionality of the user device 102 can be provided by other types of computing systems including, but not limited to, a handheld computer, a netbook computer, an embedded computer system, a mobile telephone, a smart phone, or another computing device.

Various aspects of the user device 102 are illustrated and described below. Although the functionality of the user device 102 is primarily described herein as being provided by a tablet or slate computing device, a smartphone, or a PC having a touch-sensitive display, because the functionality described herein with respect to the user device 102 can be provided by additional and/or alternative devices, it should be understood that these examples are illustrative, and should not be construed as being limiting in any way.

The user device 102 is in communication with a server computer 104 through network 106. The server computer 104 is configured to provide functionality for generating a narrated search result. The server computer 104 can be configured to execute an operating system 108 and narration generator 110. The operating system 108 is a computer program for controlling the operation of the server computer 104. The narration generator 110 is an executable program configured to execute on top of the operating system 108 to provide various functions.

In some examples, the server computer 104 receives a search query 112 from a user (not shown) using the user device 102. The server computer 104 transmits the search query 112 to an internal search engine 114 or external search engines 122 (hereinafter referred to collectively and/or generically as “external search engines 122” and individually as “external search engine 122A,” external search engine 122B,” and so forth). The internal search engine 114 and/or the external search engines 122 search their respective data stores and returns search results 116.

In other examples, the user device 102 may be in communication with the external search engines 122. The user device 102 may transmit the search query 112 to the external search engines 122. The search results 116 may be returned to the user device 102 or may be, as shown in FIG. 1, provided to the server computer 104. The presently disclosed subject matter is not limited to any particular configuration for sending the search query 112 or for receiving the search results 116.

The search query 112 can vary. The search query 112 can be a search for files, documents, or other similar data. The search query 112 can also be used to conduct a search on the Internet for websites having information pertinent to the search query 112. The presently disclosed subject matter is not limited to any particular purpose or application of the search query 112. Additionally, the search results 116 can be a combination of search results from multiple sources, such as external search engine 122A and external search engine 122B. In those examples, the narration generator 110 can analyze the search results 116 from one particular search engine as well as analyze differences in search results between multiple search engines.

The narration generator 110 receives the search results 116. The narration generator 110 analyzes the search results 116 to generated narrated results 120. As discussed above, the narrated results 120 are an organized description of the search results 116. In some examples, the narrated results 120 are a textual summary of various concepts, categories, and the like of the search results 116.

The narration generator 110 may analyze the entire search results 116 or may analyze a subset of the search results 120. For example, the narration generator 110 can be configured to analyze only a top percentage or a predetermined number of the search results 116. In those examples, analyzing a portion of the search results 116 can reduce the time and computing resources necessary to generate the narrated results 120 when viewed in comparison to analyzing all the search results.

The narration generation 110 can invoke a natural language service 124. The natural language service 124 receives the search results 116 and applies one or more data mining algorithms. For example, the natural language service 124 can use machine learning to examine and find use patterns in the search results 116.

For example, a search can be performed using the search query, “robots with emotions.” An example of the search results 116 can be:

Meet Pepper: The First Robot with Emotions—TIME
A robot designed to read—and more importantly, respond to—users' moods was unveiled this week by Softbank, a Japanese internet company. Pepper, who stands 4 . . . Search domain time.comtime.com/2845040/robot-emotions-pepper-softbank/More results

### First Robot Able to Develop and Show Emotions is Unveiled

Nao, developed by a European research team, models the first years of life and can form bonds with the people he meets When Nao is sad, he hunches his shoulders . . . Search domain www.theguardian.comtheguardian.com/technology/2010/aug/09/nao-robot-develop- . . .
   Scientists Build a Robot that can Learn Emotions|Computerworld
Lead researcher Lola Cañamero interacts with a robot that can respond to human emotions. (Photo courtesy of University of Hertfordshire) Researchers in the U.K. are
   Future of Robotics: Robots with Emotions—TechSling Weblog

In this article I will tell you about the future of the robotics and upcoming “Emotional intelligence technology” which will make it possible to design a robot with . . . Search domain www.techsling.comtechsling.com/2013/04/future-of-robotics-robots-with-em . . .

The natural language service 124 can analyze the above search results 116 by accessing the websites associated with each of the search results 116. The natural language service 124 can analyze the text in each of the web sites and extract one or more concept, categories, and the like. The natural language service 124 provides the analysis output to the narration generator 110.

The narration generator 110 receives the output from the natural language service 124 and generates a narrated version of the output. For example, using the search results 116 provided above, the natural language service 124 may determine two primary concepts: “human emotions” and “bonding with humans.” The narration generator 110 can receive the natural language service 124 and output a narrated version. For example, using the two concepts identified above, the narration generator 110 can generate the narrated results 120 as, “In the websites founds, a lot of the website talk about human emotions and how robots bond with humans.”

As can be seen from the above example, the narrated results 120 provide information about the search query 112 as well as information about the search results 116. Thus, in some examples, a user can view the narrated results 120 and determine that the search results 116 were relevant to the search query 112.

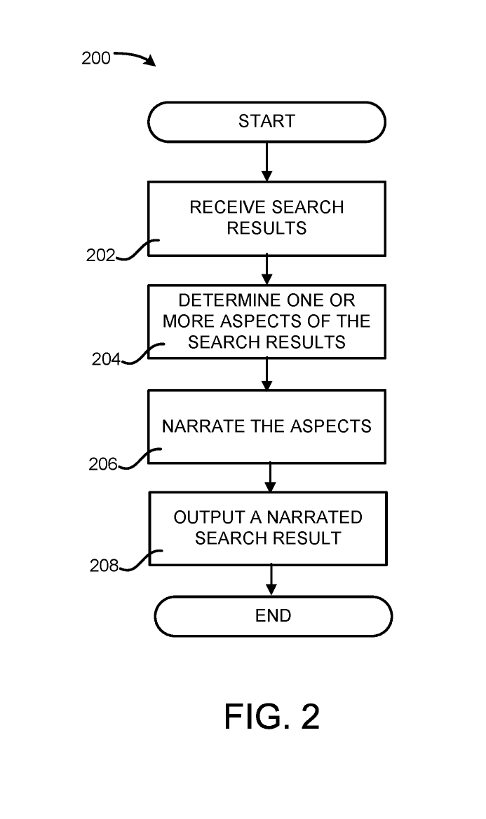

Turning now to FIG. 2, aspects of a method 200 for generating narrated results will be described in detail. It should be understood that the operations of the method 200 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated method 200 can be ended at any time and need not be performed in its entirety. Some or all operations of the method 200, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof

For purposes of illustrating and describing the technologies of the present disclosure, the method 200 disclosed herein is described as being performed by the server computer 104 via execution of computer executable instructions such as, for example, the narration generator 110. As explained above, the narration generator 110 can include functionality for generating the narrated results 120. As such, while the method 200 is described as being provided by the server computer 104, it should be understood that the server computer 104 can provide the functionality described herein via execution of various application program modules and/or elements. Additionally, devices other than, or in addition to, the server computer 104 can be configured to provide the functionality described herein via execution of computer executable instructions other than, or in addition to, the narration generator 110. As such, it should be understood that the described configuration is illustrative, and should not be construed as being limiting in any way.

The method 200 begins at operation 202, where search results 116 are received. The search results 116 can be results from Internet search engine. The search results 116 can also be results from a service for searching for files, documents, and the like on a computing device. The presently disclosed subject matter is not limited to any particular search technology. Further, the presently disclosed subject matter is not limited to using only one search engine. For example, the search results 116 be results from one or more of the external search engines 122.

The method 200 continues to operation 204, where one or more aspects are determined from the search results 116. For example, data mining, statistical analysis, machine learning, artificial intelligence, and other technologies can be used to determine various aspects of the search results.

The method 200 continues to operation 206, where the aspects are narrated. In some examples, the narration may be based on predetermined templates. For example, the predetermined templates can specify that concepts are to be the narrated output. In other examples, the predetermined templates can include other aspects like how many times the concepts were associated with academic or scholarly websites as opposed to blogs.

In further examples, the narration may be based on input received from a user. For example, along with a search query, an input may be received to apply to the search results. The input may be “what are the three most prevalent concepts found in the scholarly websites from the search results.” The narration can be a natural language output that provides a discussion of the three most prevalent concepts found in the scholarly websites from the search results.

The method 200 continues to operation 208, where the narrated search result is outputted to a requesting entity. The method 200 thereafter ends.

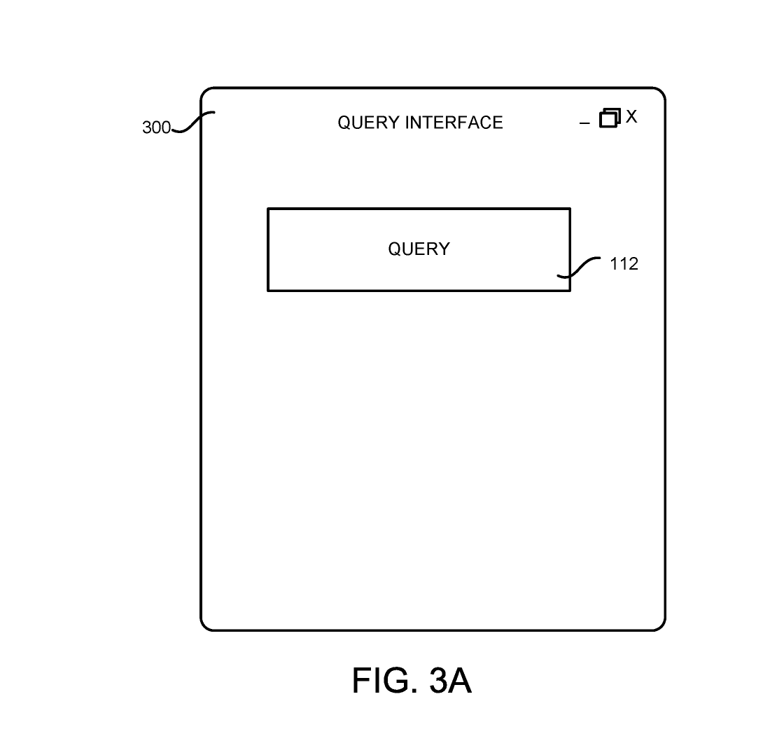

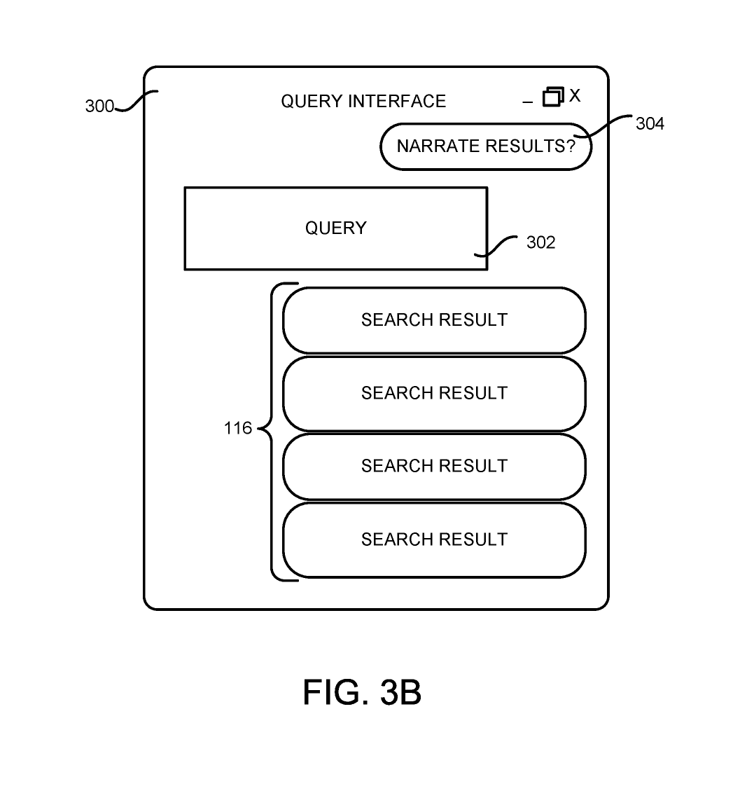

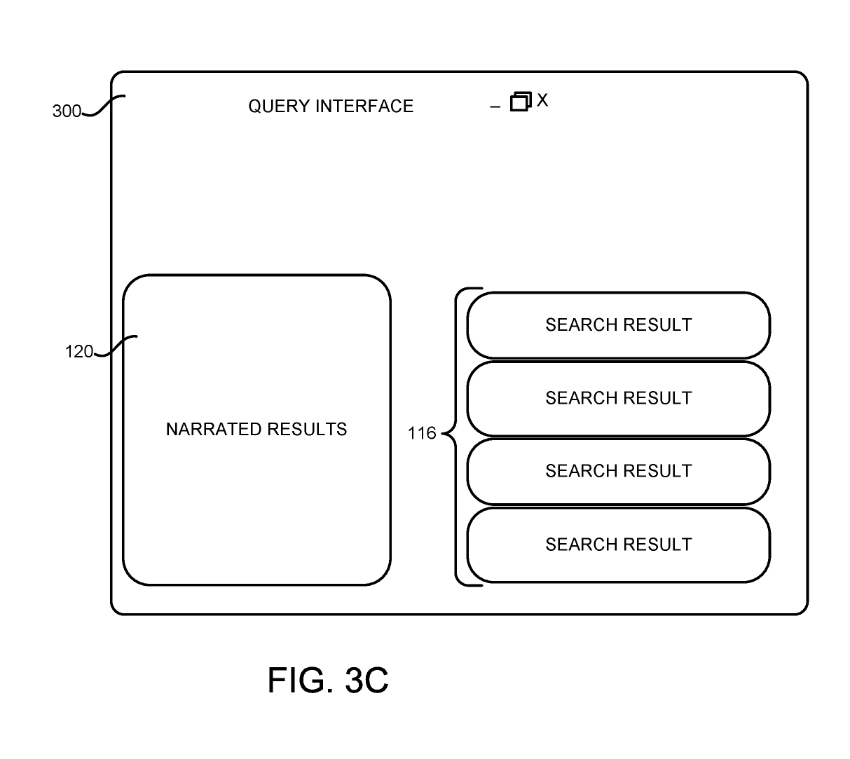

FIG. 3A shows an illustrative query interface 300 displayed by a device such as the user device 102. As shown in FIG. 3A, the query interface 300 can provide functionality for receiving a search query 112. As noted above, the search query 112 can be a query for Internet sites as well as queries for files, documents, and the like. The presently disclosed subject matter is not limited to any particular type of query. The query interface 300 receives the search query 112 and transmits the search query 112 to one or more search engines, like the internal search engine 114 or the external search engines 122.

FIG. 3B shows the illustrative query interface 300 after the search results 116 have been returned. The query interface 300 also includes a narrate results input 304. The narrate results input 304, when selected, causes the transmission of one or more of the search results 116 to the narration generator 110 to generate the narrated results 120.

FIG. 3C shows the illustrative query interface 300 after the narrated results 120 have been generated. The narrated results 120 can be displayed along with the search results 116 or can be displayed in a separate interface. The presently disclosed subject matter is not limited to any particular configuration.

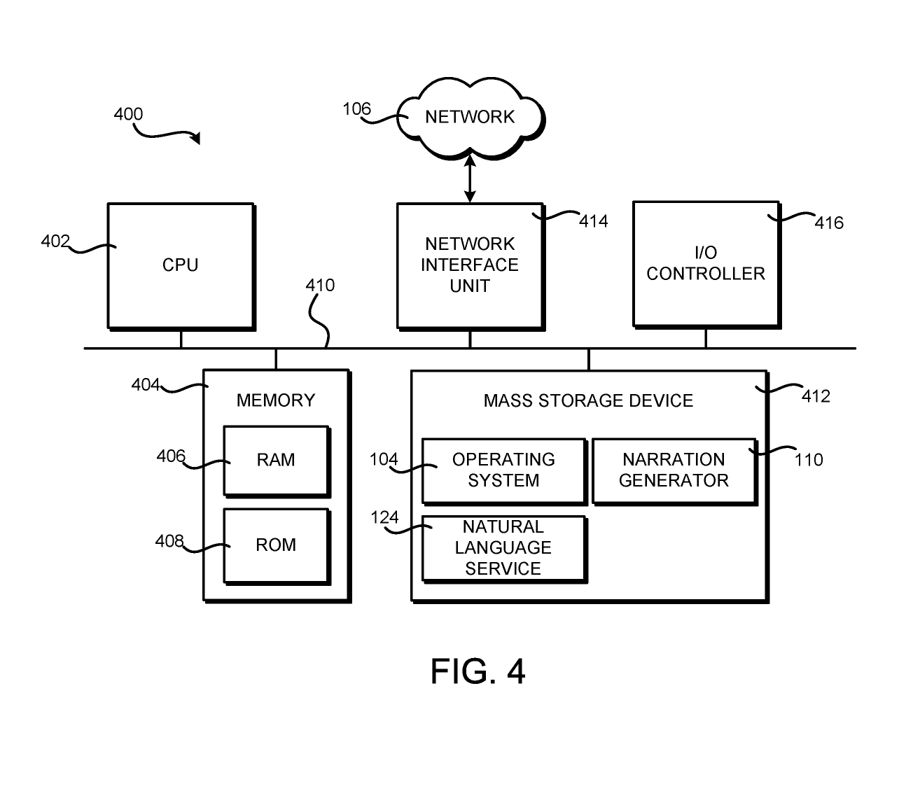

FIG. 4 illustrates an illustrative computer architecture 400 for a device capable of executing the software components described herein for generating narrated search results. Thus, the computer architecture 400 illustrated in FIG. 4 illustrates an architecture for a server computer, mobile phone, a smart phone, a desktop computer, a netbook computer, a tablet computer, and/or a laptop computer. The computer architecture 400 may be utilized to execute any aspects of the software components presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing the operating system 108 and one or more application programs including, but not limited to, the narration generator 110 and the natural language service 124.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 400 may operate in a networked environment using logical connections to remote computers through a network such as the network 106. The computer architecture 400 may connect to the network 106 through a network interface unit 414 connected to the bus 410. It should be appreciated that the network interface unit 414 also may be utilized to connect to other types of networks and remote computer systems. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

Various aspect of the presently disclosed subject matter may be considered in view of the following clauses:

Clause 1. A computer-implemented method, comprising: receiving a plurality of search results, determining one or more aspects of the search results, narrating the search results to generate narrated search results, and outputting the narrated search results.

Clause 2. The computer-implemented method of clause 1, further comprising receiving a search query.

Clause 3. The computer-implemented method of clause 1 and 2, wherein the plurality of search results are generated by one or more search engines.

Clause 4. The computer-implemented method of clauses 1 through 3, wherein the one or more search engines are external search engines that search indexed websites.

Clause 5. The computer-implemented method of clauses 1 through 4, wherein determining one or more aspects of the search results comprises applying data mining, statistical analysis, machine learning, or artificial intelligence technologies to the search results.

Clause 6. The computer-implemented method of clauses 1 through 5, wherein determining one or more aspects of the search results comprises analyzing a portion of the search results.

Clause 7. The computer-implemented method of clauses 1 through 6, wherein narrating the search results to generate the narrated search results comprises receiving the one or more aspects and determining a natural language format for the one or more aspects.

Clause 8. A computer-readable storage medium having computer readable instructions stored thereupon that, when executed by a computer, cause the computer to receive a plurality of search results, determine one or more aspects of the search results, narrate the search results to generate narrated search results, and output the narrated search results.

Clause 9. The computer-readable storage medium of clause 8, wherein the computer readable instructions further comprise computer readable instructions to receive a search query.

Clause 10. The computer-readable storage medium of clauses 8 and 9, wherein the plurality of search results are generated by one or more search engines.

Clause 11. The computer-readable storage medium of clauses 8 through 10, wherein the one or more search engines are external search engines that search indexed websites.

Clause 12. The computer-readable storage medium of clauses 8 through 11, wherein the computer readable instructions to determine one or more aspects of the search results comprises computer readable instructions to apply data mining, statistical analysis, machine learning, or artificial intelligence technologies to the search results.

Clause 13. The computer-readable storage medium of clauses 8 through 12, wherein the computer readable instructions to determine one or more aspects of the search results comprises computer readable instructions to analyze a portion of the search results.

Clause 14. The computer-readable storage medium of clauses 8 through 13, wherein the computer readable instructions to narrate the search results to generate the narrated search results comprises computer readable instructions to receive the one or more aspects and determining a natural language format for the one or more aspects.

Clause 15. A system comprising: a processor; and a computer-readable storage medium in communication with the processor, the computer-readable storage medium having computer-executable instructions stored thereupon which, when executed by the processor, cause the processor to initiate a user interface having inputs for a search query, and a narrated search results input, and generate a narrated search result from a plurality of search results received from one or more search engines.

Clause 16. The system of clause 15, further comprising computer-executable instructions to determine one or more aspects from the plurality of search results.

Clause 17. The system of clauses 15 and 16, wherein the one or more search engines comprise an internal search engine to find files or documents.

Clause 18. The system of clauses 15 through 17, wherein the one or more search engines comprise an external search engine used to search an Internet for websites.

Clause 19. The system of clauses 15 through 18, further comprising computer-executable instructions to determine one or more aspects of the search results.

Clause 20. The system of clauses 15 through 19, wherein the one or more aspects comprise buckets of similarity that are categories that can determined by statistical clustering.

Based on the foregoing, it should be appreciated that technologies for generating narrated search results have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving a plurality of search results;
determining one or more aspects of the search results;
narrating the search results to generate narrated search results; and
outputting the narrated search results.

2. The computer-implemented method of claim 1, further comprising receiving a search query.

3. The computer-implemented method of claim 1, wherein the plurality of search results are generated by one or more search engines.

4. The computer-implemented method of claim 3, wherein the one or more search engines are external search engines that search indexed web sites.

5. The computer-implemented method of claim 1, wherein determining one or more aspects of the search results comprises applying data mining, statistical analysis, machine learning, or artificial intelligence technologies to the search results.

6. The computer-implemented method of claim 1, wherein determining one or more aspects of the search results comprises analyzing a portion of the search results.

7. The computer-implemented method of claim 1, wherein narrating the search results to generate the narrated search results comprises receiving the one or more aspects and determining a natural language format for the one or more aspects.

8. A computer-readable storage medium having computer readable instructions stored thereupon that, when executed by a computer, cause the computer to:
receive a plurality of search results;
determine one or more aspects of the search results;
narrate the search results to generate narrated search results; and
output the narrated search results.

9. The computer-readable storage medium of claim 8, wherein the computer readable instructions further comprise computer readable instructions to receive a search query.

10. The computer-readable storage medium of claim 8, wherein the plurality of search results are generated by one or more search engines.

11. The computer-readable storage medium of claim 10, wherein the one or more search engines are external search engines that search indexed web sites.

12. The computer-readable storage medium of claim 8, wherein the computer readable instructions to determine one or more aspects of the search results comprises computer readable instructions to apply data mining, statistical analysis, machine learning, or artificial intelligence technologies to the search results.

13. The computer-readable storage medium of claim 8, wherein the computer readable instructions to determine one or more aspects of the search results comprises computer readable instructions to analyze a portion of the search results.

14. The computer-readable storage medium of claim 8, wherein the computer readable instructions to narrate the search results to generate the narrated search results comprises computer readable instructions to receive the one or more aspects and determining a natural language format for the one or more aspects.

15. A system comprising:
a processor; and
a computer-readable storage medium in communication with the processor, the computer-readable storage medium having computer-executable instructions stored thereupon which, when executed by the processor, cause the processor to
initiate a user interface having inputs for
a search query, and
a narrated search results input, and
generate a narrated search result from a plurality of search results received from one or more search engines.

16. The system of claim 15, further comprising computer-executable instructions to determine one or more aspects from the plurality of search results.

17. The system of claim 15, wherein the one or more search engines comprise an internal search engine to find files or documents.

18. The system of claim 15, wherein the one or more search engines comprise an external search engine used to search an Internet for websites.

19. The system of claim 15, further comprising computer-executable instructions to determine one or more aspects of the search results.

20. The system of claim 19, wherein the one or more aspects comprise buckets of similarity that are categories that can determined by statistical clustering.
